(19) United States
(12) Patent Application Publication
(10) Pub. No.: US 2024/0079706 A1
(43) Pub. Date: Mar. 7, 2024

(54) TRACTION BATTERY PACK TERMINAL RETENTION SYSTEM AND RETENTION METHOD

(71) Applicant: Ford Global Technologies, LLC, Dearborn, MI (US)

(72) Inventors: Deanna Marie Winton Hoffman, Ann Arbor, MI (US); Patrick Daniel Maguire, Ann Arbor, MI (US); Brock Dunlap, Dearborn, MI (US); Alex Revels, Canton, MI (US); Marc Dugas, Wixom, MI (US); Zeinab Jomaa, Dearborn, MI (US); Michael E. Reibling, Sterling Heights, MI (US); David Wilson, South Lyon, MI (US)

(21) Appl. No.: 18/155,008

(22) Filed: Jan. 16, 2023

Related U.S. Application Data
(60) Provisional application No. 63/403,445, filed on Sep. 2, 2022.

(51) Int. Cl. H01M 50/264; H01M 50/229; H01M 50/249; H01M 50/569

(52) U.S. Cl. CPC H01M 50/264; H01M 50/229; H01M 50/249; H01M 50/569; H01M 2220/20

(57) ABSTRACT

A battery pack terminal retention system includes a clasp configured to hold tab terminals as the tab terminals are electrically connected together. A battery pack terminal retention method includes holding terminals together using a clasp; and electrically connecting together the plurality of terminals during the holding. The terminals can be tab terminals that are electrically connected together using welds.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to securing terminals of battery cells within a traction battery pack.

### BACKGROUND

A traction battery pack of an electrified vehicle can include groups of battery cells arranged in one or more cell stacks. The battery cells can include terminals that are typically electrically connected to other terminals, a busbar, or both.

### SUMMARY

In some aspects, the techniques described herein relate to a battery pack terminal retention system, including: a clasp configured to hold a plurality of tab terminals as the tab terminals are electrically connected together.

In some aspects, the techniques described herein relate to a battery pack terminal retention system, further including a cross-member and the plurality of tab terminals, wherein the clasp engages the cross-member when holding the plurality of tab terminals.

In some aspects, the techniques described herein relate to a battery pack terminal retention system, further including sense lead secured to the cross-member, the clasp sandwiching the plurality of tab terminals against the sense lead, the cross-member, or both when holding the plurality of tab terminals.

In some aspects, the techniques described herein relate to a battery pack terminal retention system, wherein the tab terminals extend through an aperture in the cross-member when the clasp is holding the plurality of tab terminals.

In some aspects, the techniques described herein relate to a battery pack terminal retention system, wherein the plurality of tab terminals extend from a plurality of lithium-ion battery cells.

In some aspects, the techniques described herein relate to a battery pack terminal retention system, wherein the cross-member is a composite material.

In some aspects, the techniques described herein relate to a battery pack terminal retention system, wherein the clasp includes at least one hook that engages the cross-member.

In some aspects, the techniques described herein relate to a battery pack terminal retention system, wherein the at least one hook extends through aperture in the cross-member.

In some aspects, the techniques described herein relate to a battery pack terminal retention system, wherein the least one hook includes an first hook that extends through a first cross-member aperture, and a second hook that extend through a second cross-member aperture.

In some aspects, the techniques described herein relate to a battery pack terminal retention system, wherein the clasp includes an aperture that provides access to the tab terminals to join the tab terminals.

In some aspects, the techniques described herein relate to a battery pack terminal retention system, wherein an entire circumferential perimeter of the aperture is provided by the clasp.

In some aspects, the techniques described herein relate to a battery pack terminal retention system, further including a plurality of welds that electrically connect together the plurality of tab terminals.

In some aspects, the techniques described herein relate to a battery pack terminal retention system, wherein the clasp is configured to provide at least a portion of a sensing circuit path.

In some aspects, the techniques described herein relate to a battery pack terminal retention system, wherein the clasp applies a clamp load to the plurality of tab terminals when holding the plurality of tab terminals.

In some aspects, the techniques described herein relate to a battery pack terminal retention system, wherein the clasp is a sense lead.

In some aspects, the techniques described herein relate to a battery pack terminal retention system, wherein the plurality of terminals includes at least two terminals.

In some aspects, the techniques described herein relate to a battery pack terminal retention method: holding a plurality of terminals together using a clasp; and electrically connecting together the plurality of terminals during the holding.

In some aspects, the techniques described herein relate to a battery pack terminal retention method, further including biasing the plurality of terminals toward a cross-member during the holding.

In some aspects, the techniques described herein relate to a battery pack terminal retention method, further including welding together the plurality of terminals to electrically connect together the plurality of terminals.

In some aspects, the techniques described herein relate to a battery pack terminal retention method, further including welding through an aperture in the clasp when welding together the plurality of terminals.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a perspective view of a portion of the battery pack of FIG. 2 with the enclosure assembled and with areas cut away to show an outboard region of a cross-member.

FIG. 4 illustrates a perspective view of a battery cell from the battery pack of FIG. 2.

FIG. 5 illustrates a top view of selected portions of a group of battery cells from the battery pack of FIG. 2.

FIG. 6 illustrates a close-up view of an area of FIG. 3 showing a clasp engaging a cross-member to hold terminals of the battery pack.

FIGS. 7A-7E illustrate steps in a method of retaining the terminals within the battery pack of FIG. 2 using the clasp shown in FIG. 6.

FIG. 8 shows a clasp according to another exemplary aspect of the present disclosure.

### DETAILED DESCRIPTION

This disclosure details exemplary battery terminal retention systems within a traction battery pack. The systems incorporate a clasp that can engage with another structure to hold the terminals. After which, the terminals may be electrically connected together via welds, for example.

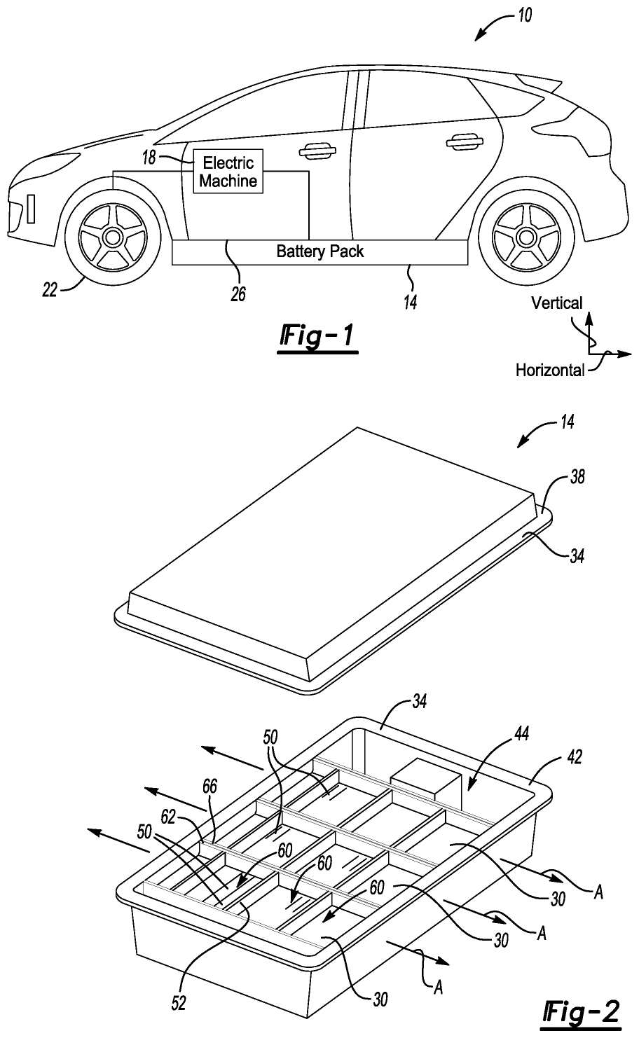

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

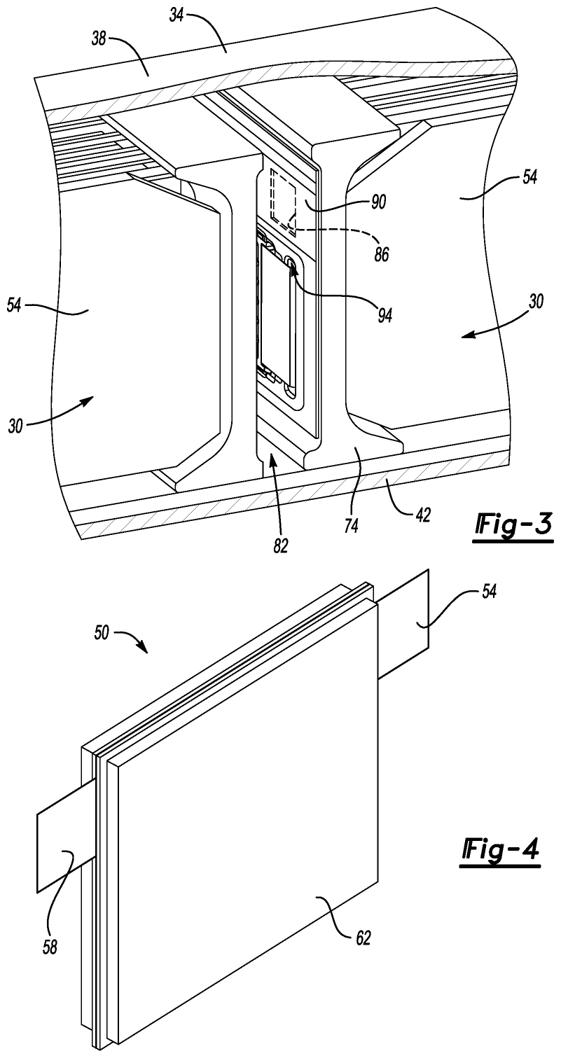

With reference now to FIGS. 2-5, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply “cells”) and at least one divider 52 distributed along a respective cell stack axis A. The battery cells 50 are stacked side-by-side relative to each other along the cell stack axis A. Plates 54 can be positioned at opposing ends of the cell stacks 30.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure. The exemplary battery cells 50 can include tab terminals 58 extending from a battery cell housing 62. An aluminum film can provide at least part of the housing 62, for example. The housing could additionally include a polymer.

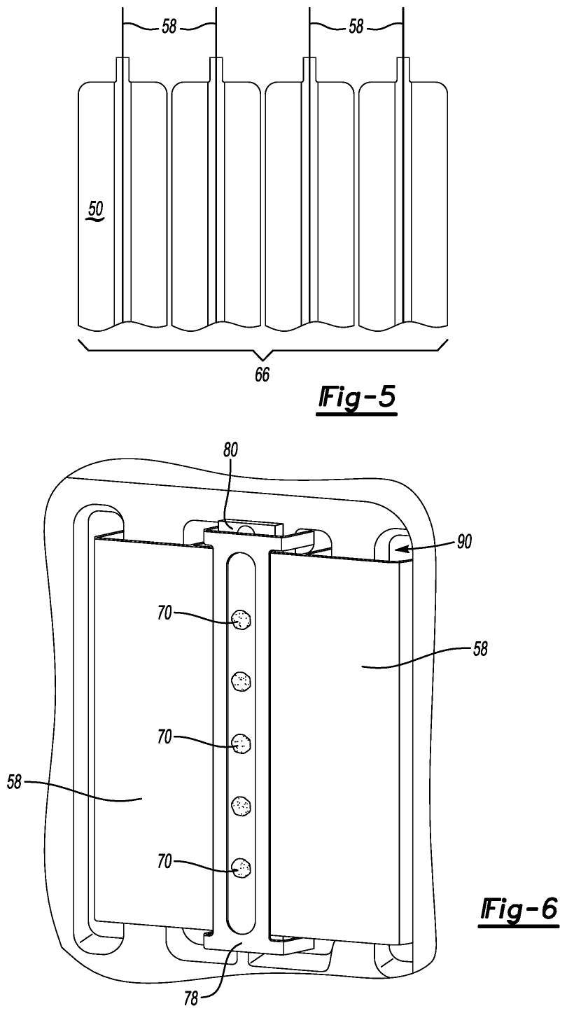

With the cell stacks 30, the tab terminals 58 of different battery cells 50 can be electrically connected together. In this example, terminals 58 from a group 66 of four battery cells 50 shown in FIG. 5 are, when installed within the battery pack 14, electrically connected together via welds 70 as shown in FIG. 6. The welds 70 are laser welds in this example, but other types joining techniques could be used including other types of welding, soldering, or clamping.

The battery pack 14 includes a plurality of cross-members 74 that, together with a clasp 78, and a backing pad 80 help to secure the terminals 58 for welding. Securing the terminals 58 can, among other things, facilitate reliably connecting the terminals 58 with the welds.

Within the battery pack 14, the cross-members 74 are configured to transfer a load applied to a side of the vehicle 10, for example. The cross-members 74 are disposed between the cell stacks 30. In this example, the cross-members 74 extend longitudinally in a cross-vehicle direction. The cross-members 74 enhance the structural integrity of the battery pack 14. The cross-members 74 are composite in this example. The cross-members 74 can primarily incorporate a polymer-based material.

In addition to helping to support the terminals 58, the cross-members 74 also help to communicate battery cell vent byproducts from the traction battery pack 14. The cross-members 74 are disposed in groups of two to establish passageways 82 that can communicate vent byproducts from the cell stacks 30 toward a position where the vent byproducts can be expelled from the battery pack 14.

The cross-members 74 include a plurality of vents 86 that are configured to receive battery cell vent byproducts from one of the cell stacks 30. The vents 86 provided a path for battery cell vent byproducts to move to the passageway 82 as required.

When the battery cells 50 in the cell stacks 30 are not venting, the vents 86 can be covered by a membranes 90 or one-way valves, for example. A pressure differential increase associated with one or more of the battery cells 50 venting can rupture the membrane 90 or open the one-way valves, so that the vent byproducts can pass through the vents 86 into the passageway 82.

In this example, the cross-members 74 include apertures 94 vertically below the vents 86. Vertical and horizontal, for purposes of this disclosure, are with reference to ground and a general orientation of battery pack 14 when installed within the vehicle 10 of FIG. 1. The terminals 58 extend through the apertures 94 when the terminals 58 are secured within the battery pack 14 as shown in FIG. 6.

The terminals 58 are secured, in the exemplary embodiment using a terminal retention system that includes a clasp. A method of securing the terminals using the system can be described as follows.

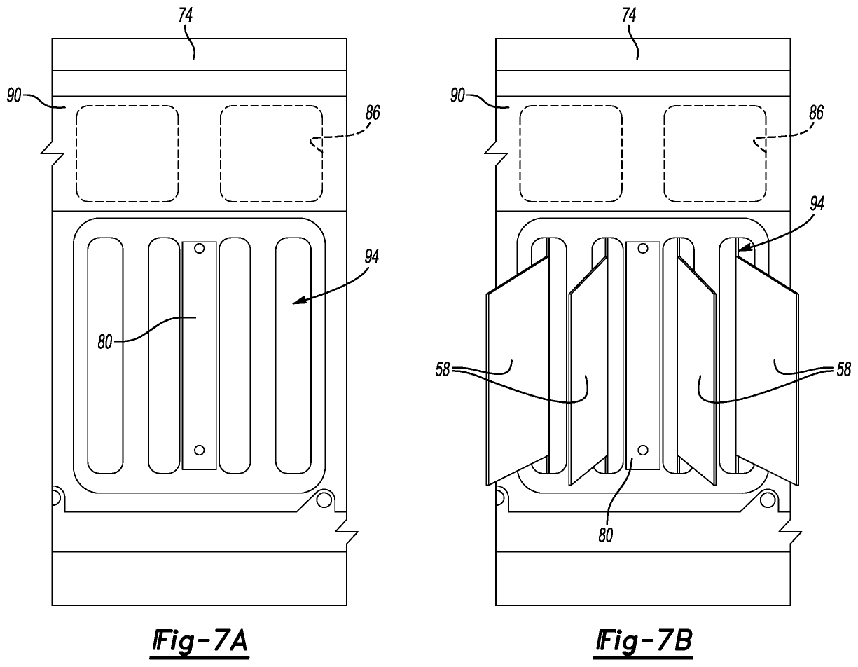

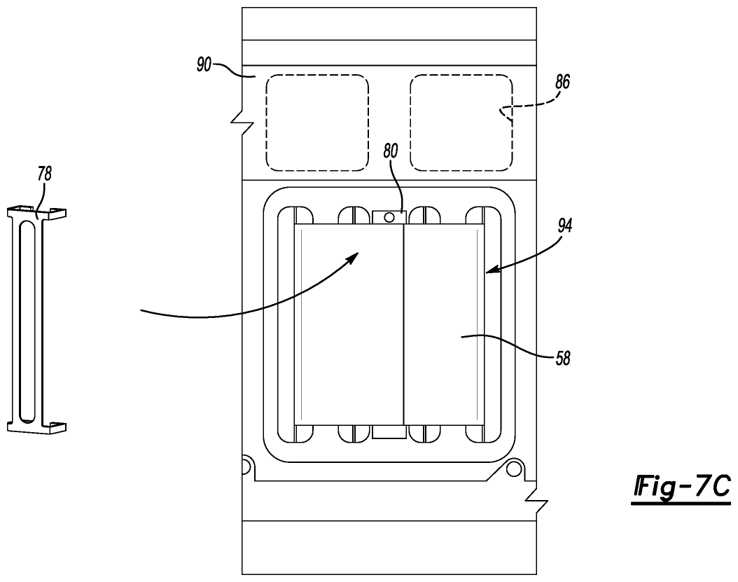

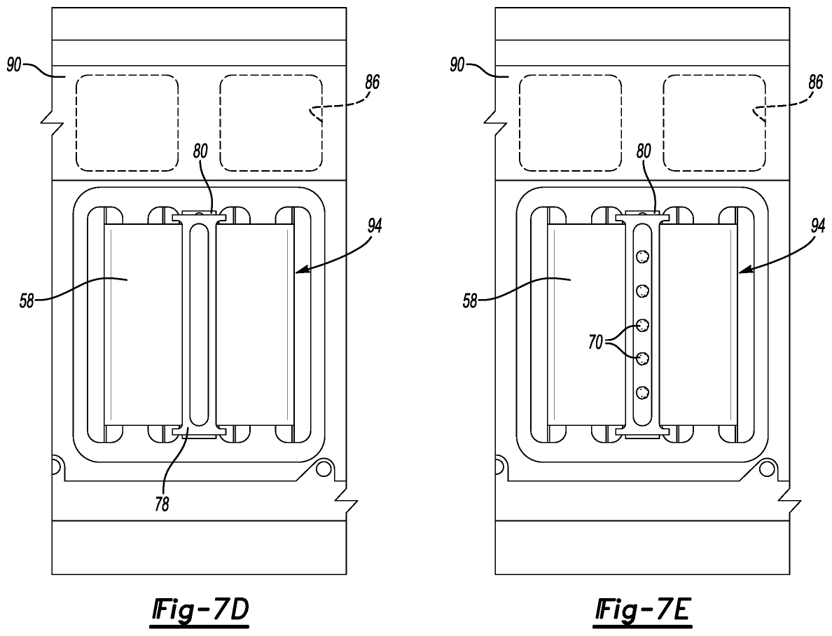

To secure the terminals 58, the terminals 58 are first extended through respective apertures 94 as shown in FIGS. 7A and 7B. The backing pad 80 is mounted adjacent to the apertures 94. The backing pad 80 can be heat-staked to the cross-member 74, for example. The backing pad 80 provides a suitable backing for welding the terminals 58. In this example, the backing pad 80 also provides a sense lead that can be used to collect data, such as voltage, from the terminals 58. In some examples, the backing pad 80 is not required and the cross-member 74 provides a suitable backing for welding the terminals 58.

The terminals 58 extend through the apertures 94 and are folded over the backing pad 80 as shown in FIG. 7C. Some of the terminals 58 are copper and some are aluminum in this example.

The clasp 78 then engages the cross-member 74 to hold the terminals 58 for welding as shown in FIG. 7D. When the clasp 78 engages the cross-member 74, the clasp 78 sandwiches the terminals 58 against the backing pad 80, which, again, is a sense lead in this example. In other examples, the clasp 78 could sandwich a portion of the terminals 58 against the cross-member 74.

The clasp 78 includes an aperture 98 through which a welder can access the terminals 58 to apply the welds 70 shown in FIG. 7E, which electrically connect the terminals 58 together.

The clasp 78 can then be removed or can remain. In other examples, the terminals 58 could be connected together using something other than the welds 70, such as an adhesive.

The aperture 98 has an entire circumferential perimeter provided by the clasp 78 in this example. In another example, the aperture 98 open to a side of the clasp 78 such that the clasp 78 does not have a perimeter entirely established by the clasp 78

The example clasps 78 include four hooks 102 that help to engage the cross-member 74. When engaged, two of the hooks 102 are above the terminals 58. The other two hooks 102 are below the terminals 58. The hooks 102 extend from the side of the cross-member 74 facing the passageway 82 to the opposite, backside of the cross-member 74. Two of the hooks 102 extend through one of the apertures 94 on a first side of the backing pad 80 and the other two hooks 102 extend through another of the apertures 94 on an opposite, second side of the backing pad 80.

The hooks 102 and the remaining portions of the clasp 78 can be designed to flex during installation. This enables the clasp 78 to exert a clamp load on the terminals 58 when holding the terminals 58. Alternatively, the cross member could include snaps, detents, or other features to allow the clamp 78 to be of a simpler, nearly flat design, and snap into the cross member. This approach can simplify manufacturing of the clip 78 as there is no need to extend tines and clips around or behind the fragile cell tabs.

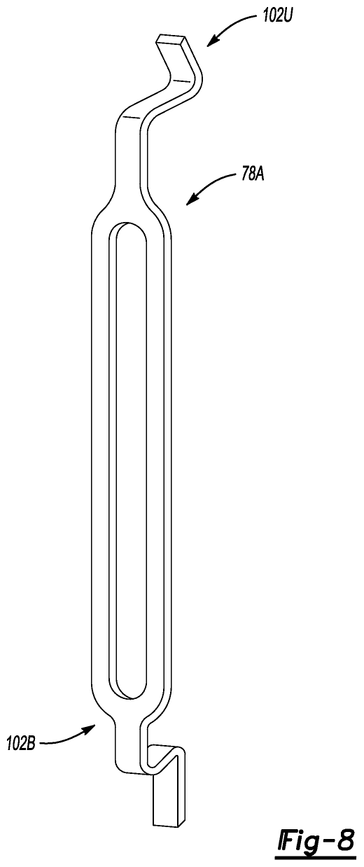

With reference to FIG. 8, another example clasp 78A has a single bottom hook 102B and a single upper hook 102U. To engage a cross-member, the bottom hook 102B can be inserted into an aperture of the cross-member—an aperture separate from the aperture receiving the terminal. The clasp 78A can then be rocked and rotated about the bottom hook 102B until the upper hook 102U is fully inserted into another aperture. The clasp 78A can be bowed when not engaging a cross-member. Engaging the cross-member straightens the bow biasing the clasp 78A against the terminals held by the clasp.

The clasps 78 and 78A are separate from the cross-members 74. The clasps 78 and 78A are each metal or metal alloy in this example. In other example, the clasp could be a polymer based material and could be a portion of the cross-member 74. Such a clasp may connect to other portions of the cross-member 74 via a living hinge.

Both the clasp 78 of FIGS. 6-7E and the clasp 78A can, in some examples, be used as sense leads. In such examples, a wire can operatively connect the clasp 78 or 78A to a control module within the battery pack 14. The clasp 78 or 78A can then collect data used when monitoring the battery pack 14. In such examples, the clasp 78 or 78A can provide a portion of a sensing circuit path used to monitor various conditions, temperature, voltages, etc.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack terminal retention system, comprising:
a clasp configured to hold a plurality of tab terminals as the tab terminals are electrically connected together.

2. The battery pack terminal retention system of claim 1, further comprising a cross-member and the plurality of tab terminals, wherein the clasp engages the cross-member when holding the plurality of tab terminals.

3. The battery pack terminal retention system of claim 2, further comprising sense lead secured to the cross-member, the clasp sandwiching the plurality of tab terminals against the sense lead, the cross-member, or both when holding the plurality of tab terminals.

4. The battery pack terminal retention system of claim 2, wherein the tab terminals extend through an aperture in the cross-member when the clasp is holding the plurality of tab terminals.

5. The battery pack terminal retention system of claim 2, wherein the plurality of tab terminals extend from a plurality of lithium-ion battery cells.

6. The battery pack terminal retention system of claim 2, wherein the cross-member is a composite material.

7. The battery pack terminal retention system of claim 2, wherein the clasp includes at least one hook that engages the cross-member.

8. The battery pack terminal retention system of claim 7, wherein the at least one hook extends through aperture in the cross-member.

9. The battery pack terminal retention system of claim 8, wherein the least one hook includes an first hook that extends through a first cross-member aperture, and a second hook that extend through a second cross-member aperture.

10. The battery pack terminal retention system of claim 1, wherein the clasp includes an aperture that provides access to the tab terminals to join the tab terminals.

11. The battery pack terminal retention system of claim 10, wherein an entire circumferential perimeter of the aperture is provided by the clasp.

12. The battery pack terminal retention system of claim 1, further comprising a plurality of welds that electrically connect together the plurality of tab terminals.

13. The battery pack terminal retention system of claim 1, wherein the clasp is configured to provide at least a portion of a sensing circuit path.

14. The battery pack terminal retention system of claim 1, wherein the clasp applies a clamp load to the plurality of tab terminals when holding the plurality of tab terminals.

15. The battery pack terminal retention system of claim 1, wherein the clasp is a sense lead.

16. The battery pack terminal retention system of claim 1, wherein the plurality of terminals includes at least two terminals.

17. A battery pack terminal retention method:
holding a plurality of terminals together using a clasp; and
electrically connecting together the plurality of terminals during the holding.

18. The battery pack terminal retention method of claim 17, further comprising biasing the plurality of terminals toward a cross-member during the holding.

19. The battery pack terminal retention method of claim 17, further comprising welding together the plurality of terminals to electrically connect together the plurality of terminals.

20. The battery pack terminal retention method of claim 19, further comprising welding through an aperture in the clasp when welding together the plurality of terminals.
